(19) United States
(12) Patent Application Publication
(10) Pub. No.: US 2026/0259952 A1
(43) Pub. Date: Sep. 3, 2026

(54) POLYNOMIAL MULTIPLICATION APPARATUS, POLYNOMIAL MULTIPLICATION METHOD, POLYNOMIAL MULTIPLICATION PROGRAM, POLYNOMIAL MULTIPLICATION SOURCE CODE GENERATION APPARATUS, POLYNOMIAL MULTIPLICATION SOURCE CODE GENERATION METHOD, AND POLYNOMIAL MULTIPLICATION SOURCE CODE GENERATION PROGRAM

(71) Applicant: NEC Corporation, Minato-ku, Tokyo (JP)

(72) Inventor: Daichi AOKI, Tokyo (JP)

(73) Assignee: NEC Corporation, Minato-ku, Tokyo (JP)

(21) Appl. No.: 18/718,480

(22) PCT Filed: Dec. 15, 2021
(86) PCT No.: PCT/JP2021/046296

§ 371 Date: Jun. 11, 2024

(51) Int. Cl. G06F 17/14; G06F 17/16; H04L 9/30

(52) U.S. Cl. CPC G06F 17/144; G06F 17/16; H04L 9/3093

(57) ABSTRACT

A polynomial multiplication apparatus multiplying a square matrix and a vector having polynomial elements that are elements of a polynomial ring, the polynomial multiplication apparatus includes: an NTT structure determination part that computes an optimal number of layers of number theoretic transforms for inputs of the cycle ratio of the cycle count per one execution of a modular arithmetic function to the cycle count per one execution of multiplication in the polynomial multiplication apparatus and the order of the square matrix and the vector; and an NTT multiplication part that executes polynomial multiplication of the square matrix and the vector using a number theoretic transform that uses the optimal number of layers of number theoretic transforms.

### TECHNICAL FIELD

The present invention relates to a polynomial multiplication apparatus, polynomial multiplication method, polynomial multiplication program, polynomial multiplication source code generation apparatus, polynomial multiplication source code generation method, and polynomial multiplication source code generation program.

### BACKGROUND

The number theoretic transform (NTT) is a technique similar to the fast Fourier transform (FFT), concretely referring to the fast Fourier transform over a residue ring. NTTs are utilized in algorithms that quickly calculate multiplication between polynomials. In a type of public key cryptography, known as lattice-based cryptography, whose security is based on the computational difficulty of mathematical problems called lattice problems, polynomial rings are often used. Therefore, fast polynomial multiplication algorithms are of practical importance, often utilizing NTTs.

In NTT-based polynomial multiplication, each polynomial to be multiplied is transformed using the NTT and multiplied in that transformed state. Then, the result is transformed using the inverse number theoretic transform. NTT-based polynomial multiplication is thus able to obtain the desired polynomial multiplication. The NTT is a multi-layer transformation, and Non-Patent Literature 1 describes a technique that reduces the computational complexity by stopping multi-layer number theoretic transforms midway through and performing the inverse number theoretic transform.

### CITATION LIST

### Non-Patent Literature

### Non-Patent Literature 1

Chi-Ming Marvin, et al., “NTT Multiplication for NTT-unfriendly Rings,” Cryptology ePrint Archive, Report 2020/1397.

### SUMMARY

### Technical Problem

The disclosure of the literature in Citation List above is incorporated herein in its entirety by reference thereto. The following analysis is given by the present inventors.

In NTT-based polynomial multiplication, a trade-off is created by stopping the NTT midway through and performing the inverse NTT. Steps in NTT-based polynomial multiplication include: 1. NTT, 2. multiplication, and 3. inverse NTT. If the NTT step is stopped midway through to perform the inverse NTT, the computational complexity in 1. NTT and 3. inverse NTT can be reduced; however, this will increase the computational complexity in 2. multiplication. On this point, Non-Patent Literature 1 determines the optimal number of layers for the NTT on the basis of information such as the number of registers in the CPU running the program and the cycle count of basic instructions.

However, the optimal number of layers may vary depending on not only the CPU architecture but also on how the modular arithmetic functions, which are the unit operations of the NTT, are implemented. Implementing the optimal number of NTTs for different CPU architectures and different implementations of modular arithmetic functions is considered challenging.

In view of the problem above, it is an object of the present invention to provide a polynomial multiplication apparatus, polynomial multiplication method, polynomial multiplication program, polynomial multiplication source code generation apparatus, polynomial multiplication source code generation method, and polynomial multiplication source code generation program that contribute to reducing the computational complexity of a polynomial multiplication algorithm.

### Solution to Problem

According to a first aspect of the present invention, there is provided a polynomial multiplication apparatus multiplying a square matrix and a vector having polynomial elements that are elements of a polynomial ring, the polynomial multiplication apparatus comprising: an NTT structure determination part that computes an optimal number of layers of number theoretic transforms for inputs of the cycle ratio of the cycle count per one execution of a modular arithmetic function to the cycle count per one execution of multiplication in the polynomial multiplication apparatus and the order of the square matrix and the vector; and an NTT multiplication part that executes polynomial multiplication of the square matrix and the vector using a number theoretic transform that uses the optimal number of layers of number theoretic transforms.

According to a second aspect of the present invention, there is provided a polynomial multiplication method using a computer to multiply a square matrix and a vector having polynomial elements that are elements of a polynomial ring, the polynomial multiplication method including: computing an optimal number of layers of number theoretic transforms for inputs of the cycle ratio of the cycle count per one execution of a modular arithmetic function to the cycle count per one execution of multiplication in the computer and the order of the square matrix and the vector; and executing polynomial multiplication of the square matrix and the vector using a number theoretic transform that uses the optimal number of layers of number theoretic transforms.

According to a third aspect of the present invention, there is provided a polynomial multiplication program causing a computer to multiply a square matrix and a vector having polynomial elements that are elements of a polynomial ring, the polynomial multiplication program including: a process of computing an optimal number of layers of number theoretic transforms for inputs of the cycle ratio of the cycle count per one execution of a modular arithmetic function to the cycle count per one execution of multiplication in the computer and the order of the square matrix and the vector; and a process of executing polynomial multiplication of the square matrix and the vector using a number theoretic transform that uses the optimal number of layers of number theoretic transforms.

According to a fourth aspect of the present invention, there is provided a polynomial multiplication source code generation apparatus comprising: an input part that takes as inputs a file containing the source code of a modular arithmetic function, the cycle ratio of the cycle count per one execution of the modular arithmetic function to the cycle count per one execution of multiplication, and a square matrix order; a number theoretic transform layer determination part that computes an optimal number of number theoretic transform layers from the cycle ratio and the order; an output constant generation part that generates a twiddle factor, a modulo, and a normalization factor for the optimal number of layers of number theoretic transforms and inverse number theoretic transforms to output a list thereof; a polynomial multiplication source file generation part that generates a file in which a function computing the product of a square matrix and a vector of the order is implemented in the same program as that of the source file; and a file output part that outputs the file and the list.

According to a fifth aspect of the present invention, there is provided a polynomial multiplication source code generation method including: taking as inputs a file containing the source code of a modular arithmetic function, the cycle ratio of the cycle count per one execution of the modular arithmetic function to the cycle count per one execution of multiplication, and a square matrix order; computing an optimal number of number theoretic transform layers from the cycle ratio and the order; generating a twiddle factor, a modulo, and a normalization factor for the optimal number of layers of number theoretic transforms and inverse number theoretic transforms to output a list thereof; generating a file in which a function computing the product of a square matrix and a vector of the order is implemented in the same program as that of the source file; and outputting the file and the list.

According to a sixth aspect of the present invention, there is provided a polynomial multiplication source code generation program causing a computer to execute processes of: taking as inputs a file containing the source code of a modular arithmetic function, the cycle ratio of the cycle count per one execution of the modular arithmetic function to the cycle count per one execution of multiplication, and a square matrix order; computing an optimal number of number theoretic transform layers from the cycle ratio and the order; generating a twiddle factor, a modulo, and a normalization factor for the optimal number of layers of number theoretic transforms and inverse number theoretic transforms to output a list thereof; generating a file in which a function computing the product of a square matrix and a vector of the order is implemented in the same program as that of the source file; and outputting the file and the list.

Further, the programs above can be stored in a computer-readable storage medium. The storage medium may be a non-transient one such as a semiconductor memory, a hard disk, a magnetic recording medium, an optical recording medium, and the like. The present invention can also be realized as a computer program product.

### Advantageous Effects of Invention

According to each aspect of the present invention, there can be provided a polynomial multiplication apparatus, polynomial multiplication method, polynomial multiplication program, polynomial multiplication source code generation apparatus, polynomial multiplication source code generation method, and polynomial multiplication source code generation program that contribute to reducing the computational complexity of a polynomial multiplication algorithm.

### BRIEF DESCRIPTION OF DRAWINGS

FIG. 1 is a drawing showing an example of a binary tree in the number theoretic transform.

FIG. 2 is a block diagram of a polynomial multiplication apparatus relating to a first example embodiment.

FIG. 3 is a flowchart of a polynomial multiplication method relating to the first example embodiment.

FIG. 4 is a drawing showing an example of the hardware configuration of the apparatus used in the example embodiments.

FIG. 5 is a graph showing the predicted values and the actual measured values of the number L of NTT layers and the CPU cycle count (×10³).

FIG. 6 is a drawing showing an example of the configuration of a key generation apparatus incorporating the polynomial multiplication apparatus.

FIG. 7 is a drawing showing an example of the configuration of an encryption apparatus incorporating the polynomial multiplication apparatus.

FIG. 8 is a block diagram showing the configuration of a polynomial multiplication source code generation apparatus.

FIG. 9 is a flowchart showing a polynomial multiplication source code generation method.

### EXAMPLE EMBODIMENT

Example embodiments of the present invention will be described with reference to the drawings. The present invention, however, is not limited to the example embodiments described below. Further, in each drawing, the same or corresponding elements are appropriately designated by the same reference signs. It should also be noted that the drawings are schematic, and the dimensional relationships and the ratios between the elements may differ from the actual ones. There may also be parts where the dimensional relationships and the ratios between drawings are different.

### First Example Embodiment

First, a fundamental polynomial multiplication algorithm using the number theoretic transform will be described.

Let an integer n be a power of 2 (i.e., n=2^{m}) and F(X) be an (n−1) degree polynomial having elements of a residue ring R as its coefficients. In addition, let z be a primitive nth root of unity of the residue ring R. Further, let NTT(F) be the number theoretic transform algorithm for an input to the polynomial F(X), then NTT(F)=(F(z⁰), F(z¹), . . . , F(zⁿ⁻¹)).

The value F(zⁱ) for each i=0, 1, . . . , n−1 can be obtained by recursively applying the following map M:

$$M : R [ X ] / ( {X}^{2 n} - {w}^{2} ) -> R [ X ] / ( {X}^{n} - w ) \times R [ X ] / ( {X}^{n} + w )$$

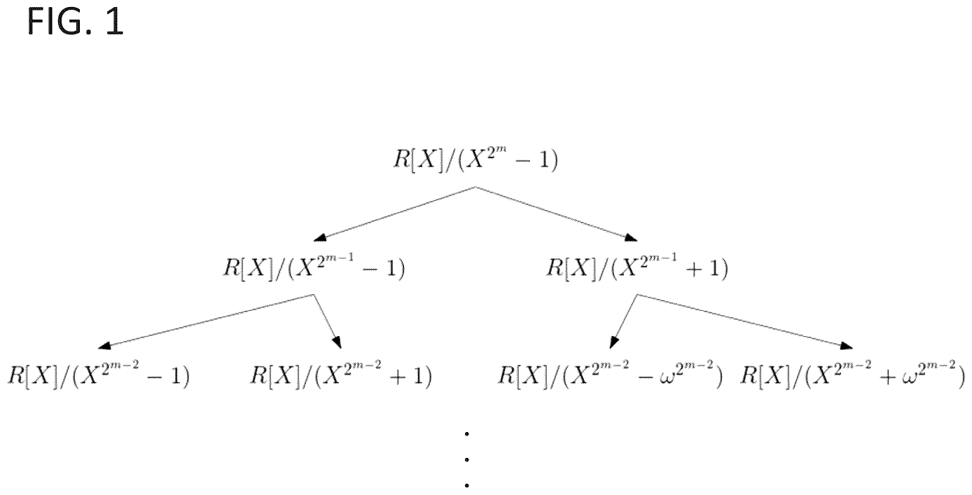

In other words, as shown in FIG. 1, construct a binary tree, having an element F of a polynomial ring R[X]/(Xⁿ−1) at its root, where each parent has as children two polynomials obtained by applying the map M to the parent's polynomial, then a binary tree of height log₂(n) is obtained and F(z⁰), . . . , F(zⁿ⁻¹) are assigned to each of n leaves. Hereinafter, the height of this binary tree will be referred to as the number of NTT layers.

Meanwhile, by using the inverse mapping of M, the series of steps can be traced backward. In other words, by constructing the binary tree in the reverse direction from the set of values F(z⁰), . . . , F(zⁿ⁻¹) assigned to n leaves, the polynomial F at the root can be derived. This is referred to as the inverse number theoretic transform and is denoted as NTTᵢₙᵥ. Therefore, NTTᵢₙᵥ(NTT(F))=F holds true.

To compute a product H of the element F and an element G of the polynomial ring R[X]/(Xⁿ−1) using the NTT described above, do as follows:

First, derive NTT (F)=(F(z⁰), . . . , F(zⁿ⁻¹)) and NTT(G)=(G(z⁰), . . . , G(zⁿ⁻¹)). Next, calculate NTT(F)×NTT(G)=(F(z⁰)×G(z⁰), . . . , F(zⁿ⁻¹)×G(zⁿ⁻¹)). Finally, by applying the inverse NTT to this, NTTᵢₙᵥ(NTT(F)×NTT(G)) is obtained and equals to the desired product H of F and G.

Meanwhile, the polynomial multiplication algorithm described above transforms the element F of the polynomial ring R[X]/(Xⁿ−1) up to the log₂(n)-th NTT layer. On the other hand, as stated above, it may be possible to reduce the computational complexity by stopping the NTT process midway through, performing polynomial multiplication, and performing the inverse NTT. For instance, if the number of NTT layers is decreased from log₂(n) to log₂(n)−1, the output of NTT(F) will be n/2 linear polynomials. Then, by multiplying linear polynomials and performing the inverse NTT, the computational complexity in both the NTT and the inverse NTT can be reduced. Note that, if the number of NTT layers is decreased from log₂(n) to log₂(n)−1, the part where multiplication of zeroth-degree polynomials (constants) is sufficient will involve multiplication of linear polynomials, leading to an increase in computational complexity for this part.

In this trade-off relationship, the present invention derives the optimal number L of NTT layers from the following formula and executes the polynomial multiplication algorithm using this number of layers L.

$$\begin{matrix}[ Math . 1 ] & \\ L = floor ( m + {log}_{2} ( \frac{2 + k}{2 k} ) + {log}_{2} ( 1 - \sqrt{1 - {( \frac{2 k}{2 + k} )}^{2} \cdot \frac{2}{1 + r}} ) ) & ( 1 )\end{matrix}$$

Note that, in the above formula, floor (x) is the greatest integer that does not exceed a real number x. Further, a cycle ratio r is defined as r=a/b, where a is the cycle count per one execution of a modular arithmetic function and b is the cycle count per one execution of multiplication, and for instance, an actual measured value can be used for this cycle ratio r. The polynomial multiplication algorithm using the NTT can be extended to the product As of a k×k square matrix A having polynomial elements and a k-dimensional vector s having polynomial elements, where k in the above formula is the order of the square matrix. Note that, when k=1, it becomes the usual multiplication of polynomials. Further, m is a number such that n=2^{m} for the residue ring R[X]/(Xⁿ−1) to which the multiplied polynomials belong. In other words, m=log₂(n) holds true.

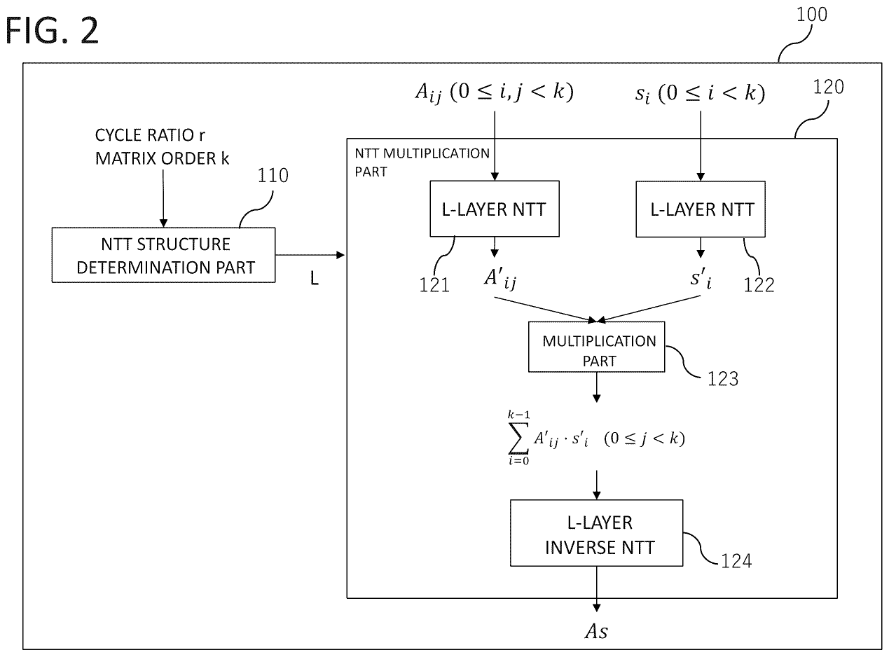

FIG. 2 is a block diagram of a polynomial multiplication apparatus relating to the first example embodiment. As shown in FIG. 2, the polynomial multiplication apparatus 100 that implements the polynomial multiplication algorithm relating to the first example embodiment comprises an NTT structure determination part 110 and an NTT multiplication part 120. The NTT structure determination part 110 computes the optimal number L of NTT layers for inputs of the cycle ratio r and the matrix order k using the formula above. Meanwhile, using the optimal number L of NTT layers computed by the NTT structure determination part 110, the NTT multiplication part 120 executes the polynomial multiplication algorithm using NTTs.

In more detail, the NTT multiplication part 120 comprises a first L-layer number theoretic transform part 121, a second L-layer number theoretic transform part 122, a multiplication part 123, and a L-layer inverse number theoretic transform part 124. The first L-layer number theoretic transform part 121 performs an L-layer number theoretic transform on each element Aᵢⱼ for an input of the k×k square matrix A having polynomial elements. Meanwhile, the second L-layer number theoretic transform part 122 performs an L-layer number theoretic transform on each element sᵢⱼ for an input of the k-dimensional vector s having polynomial elements.

The multiplication part 123 performs matrix-vector multiplication for outputs of the first L-layer number theoretic transform part 121 and the second L-layer number theoretic transform part 122. The L-layer inverse number theoretic transform part 124 performs the inverse number theoretic transform on the result of multiplication performed by the multiplication part 123. As described, the NTT multiplication part 120 outputs the product As of the k×k square matrix A and the k-dimensional vector s for inputs of the k×k square matrix A having polynomial elements and the k-dimensional vector s having polynomial elements.

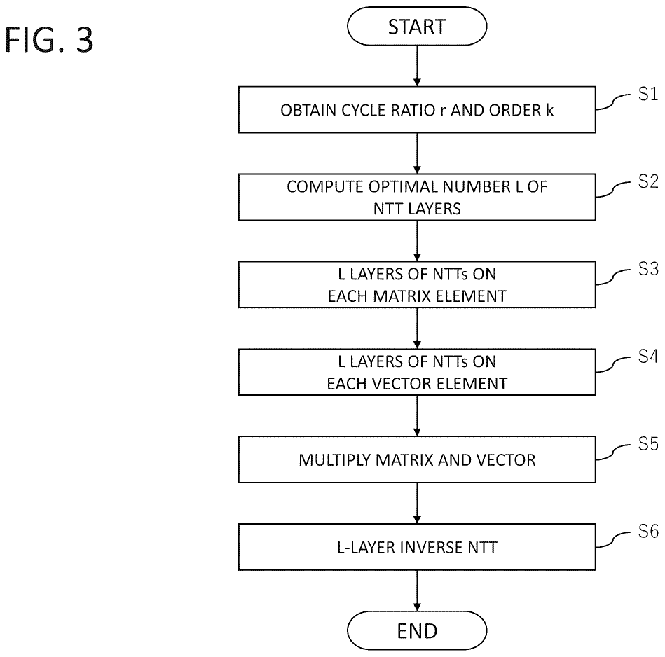

FIG. 3 is a flowchart of a polynomial multiplication method relating to the first example embodiment. The polynomial multiplication method relating to the first example embodiment shown in FIG. 3 uses a computer to multiply a square matrix and a vector having polynomial elements with elements of a residue ring as the coefficients thereof.

As shown in FIG. 3, the polynomial multiplication method relating to the first example embodiment comprises a step (S1) of acquiring the cycle ratio r and the order k, a step (S2) of computing the optimal number L of NTT layers, a step (S3) of performing L layers of NTTs on each element of the matrix, a step (S4) of performing L layers of NTTs on each element of the vector, a step (S5) of multiplying the matrix and the vector, and a step (S6) of performing L layers of inverse NTTs.

In the step (S1) of acquiring the cycle ratio r and the order k, the ratio r=a/b of the cycle count a per one execution of a modular arithmetic function to the cycle count b per one execution of multiplication and the order k of the matrix and the vector to be multiplied are acquired. Note that, for instance, an actual measured value can be used for the cycle ratio r.

In the step (S2) of computing the optimal number L of NTT layers, the optimal number L of NTT layers are computed from the cycle ratio r and the order k using the mathematical formula above.

In the step (S3) of performing L layers of NTTs on each element of the matrix and the step (S4) of performing L layers of NTTs on each element of the vector, L (the computed number) layers of NTTs are performed on each element of the matrix and the vector.

In the step (S5) of multiplying the matrix and the vector, the matrix and the vector whose elements have undergone the number theoretic transforms are multiplied, and in the step (S6) of performing L layers of inverse NTTs, the inverse NTT is performed on the multiplication result.

As described, the polynomial multiplication method relating to the first example embodiment reduces the computational complexity by performing the number theoretic transform with the optimal number of layers L.

### (Hardware Configuration)

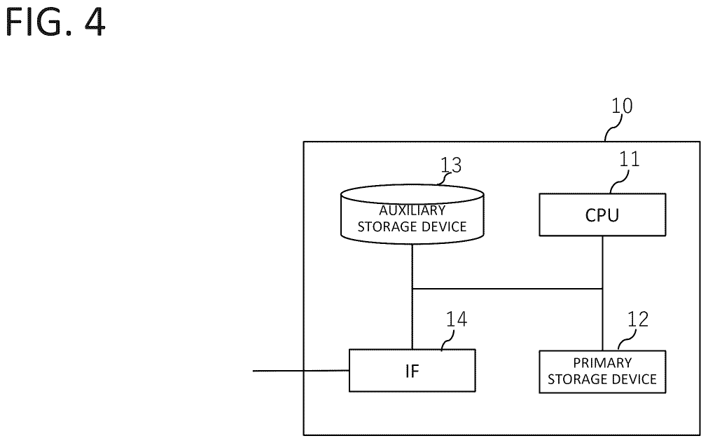

FIG. 4 is a drawing showing an example of the hardware configuration of the apparatus used in the example embodiments. In other words, the polynomial multiplication apparatus 100 is able to achieve the functions thereof by causing an information processing apparatus (computer) employing the hardware configuration shown in FIG. 4 to execute the polynomial multiplication method described above as a program. It should be noted that the hardware configuration example shown in FIG. 4 is merely an example of the hardware configuration that achieves the functions of the polynomial multiplication apparatus 100 and is not intended to limit the hardware configuration of the polynomial multiplication apparatus 100. The polynomial multiplication apparatus 100 may include hardware not shown in FIG. 4.

As shown in FIG. 4, the hardware configuration 10 that may be employed by the polynomial multiplication apparatus 100 comprises a CPU (Central Processing Unit) 11, a primary storage device 12, an auxiliary storage device 13, and an IF(interface) part 14, which are connected to each other by, for instance, an internal bus.

The CPU 11 executes each instruction included in the program executed by the polynomial multiplication apparatus 100. The primary storage device 12 is, for instance, a RAM (Random Access Memory) and temporarily stores various programs such as the program executed by the polynomial multiplication apparatus 100 so that the CPU 11 can process the programs.

The auxiliary storage device 13 is, for instance, an HDD (Hard Disk Drive) and is capable of storing the various programs, such as the program executed by the polynomial multiplication apparatus 100, in the medium to long term. The various programs such as the program may be provided as a program product stored in a non-transitory computer-readable storage medium.

The IF part 14 provides an interface related to, for instance, the input and output of the polynomial multiplication apparatus 100.

The information processing apparatus employing the hardware configuration 10 described above achieves the functions of, for instance, the polynomial multiplication apparatus 100 by executing the polynomial multiplication method explained above as a program.

### Verification Example

Here, the effect of the polynomial multiplication method relating to the first example embodiment will be described. The environment for the verification experiment is as follows:

### Experiment Environment

Microcontroller board: F103RB (ARM Cortex-M3 32-bit/72 MHz)
Compiler: gcc
Compile option: −O2

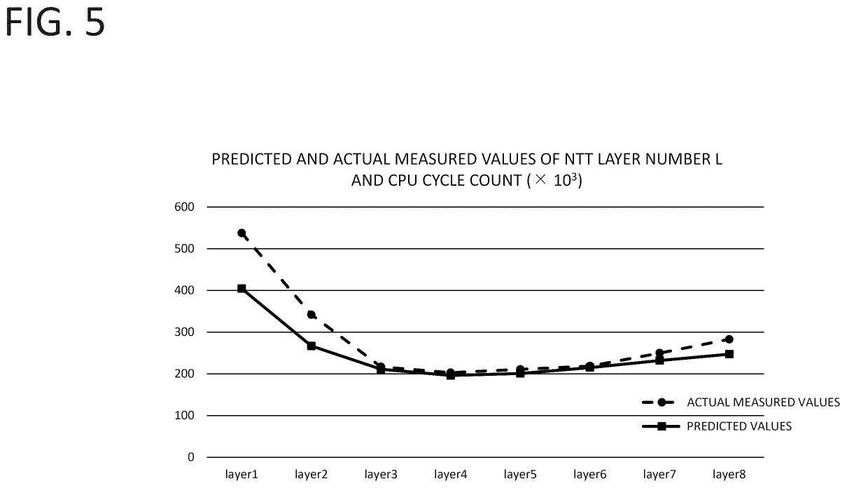

FIG. 5 is a graph showing the predicted values and the actual measured values of the number L of NTT layers and the CPU cycle count (×10³) when the number L of NTT layers is varied from one to eight in the environment described above. As shown in FIG. 5, when the layer number L is four, the computational complexity is the smallest in the above environment.

Meanwhile, if the optimal number of layers L is computed using Math. 1 above, L=4 is obtained with m=8, k=1, and an actual measured value of 5.9 (r=59/10) as the cycle ratio r. In other words, one was able to compute the optimal number of layers L using Math. 1 above.

### Second Example Embodiment

Next, the following describes an example embodiment in which the polynomial multiplication algorithm described above is applied to cryptography.

Lattice-based cryptography is a type of public key cryptography considered to be resistant to decryption even by quantum computers. A polynomial ring R_{q}=(Z/qZ)[X]/(Xⁿ+1) is a commonly used ring in lattice-based cryptography; therefore efficiently computing the product of polynomials over this ring is crucial for practical applications. Indeed, in one type of lattice-based cryptography called SABER, key generation and encryption involve the multiplication of a square matrix and a vector both having polynomial elements that are elements of the polynomial ring.

SABER is a public key cryptographic scheme based on the computational difficulty of the Module Learning with Rounding (MLWR) problem. The following describes the SABER algorithm. Parameters q, p, and T are all powers of 2 and satisfy q>p>T.

A key generation algorithm begins by uniformly selecting a matrix A∈R_{q}^{k×k} at random and then generates s∈R_{q}^{k} as a secret key. Each coefficient of s is independently sampled from a binomial distribution. Finally, the value below is calculated by scaling and rounding A^{T}s and (A, b) is outputted as a public key.

$$\begin{matrix}[ Math . 2 ] & \\ b = ⌊ \frac{p}{q} \cdot {A}^{T} s ⌉ mod p ∈ {R}_{q}^{k} & \end{matrix}$$

An encryption algorithm receives the public key (A, b) and a n-bit plaintext m as inputs. The plaintext m is expressed as a polynomial. In other words, for i∈{0, 1, . . . , N−1}, the coefficient of the term of degree i of the plaintext corresponds to the i-th bit of the plaintext. Next, s′∈R_{q}^{k} is sampled from a binomial distribution, and the following values is calculated.

$$\begin{matrix}[ Math . 3 ] & \\ {b}^{′} = ⌊ \frac{p}{q} \cdot {As}^{′} ⌉ mod p & \end{matrix}$$

Finally, v′∈R_{q} and cₘ∈R_{T} are defined as follows, and (cₘ, b′) is outputted as a ciphertext.

$$\begin{matrix}[ Math . 4 ] & \\ {v}^{′} = {b}^{T} ( {s}^{′} mod p ) , {c}_{m} = ⌊ \frac{T}{p} \cdot ( {v}^{′} - \frac{p}{2} \cdot m ⌉ mod T & \end{matrix}$$

A decryption algorithm receives the secret key s∈R_{q}^{k} and the ciphertext (cₘ, b′) as inputs. First, v=b′^{T}(s mod p)∈R_{q} is determined, and the plaintext can be reconstructed as follows:

$$\begin{matrix}[ Math . 5 ] & \\ {m}^{′} = ⌊ \frac{2}{p} \cdot ( v - \frac{p}{T} \cdot {c}_{m} ⌉ & \end{matrix}$$

In the cryptographic scheme described above, the polynomial multiplication method relating to the first example embodiment can be utilized as a key generation method and an encryption method.

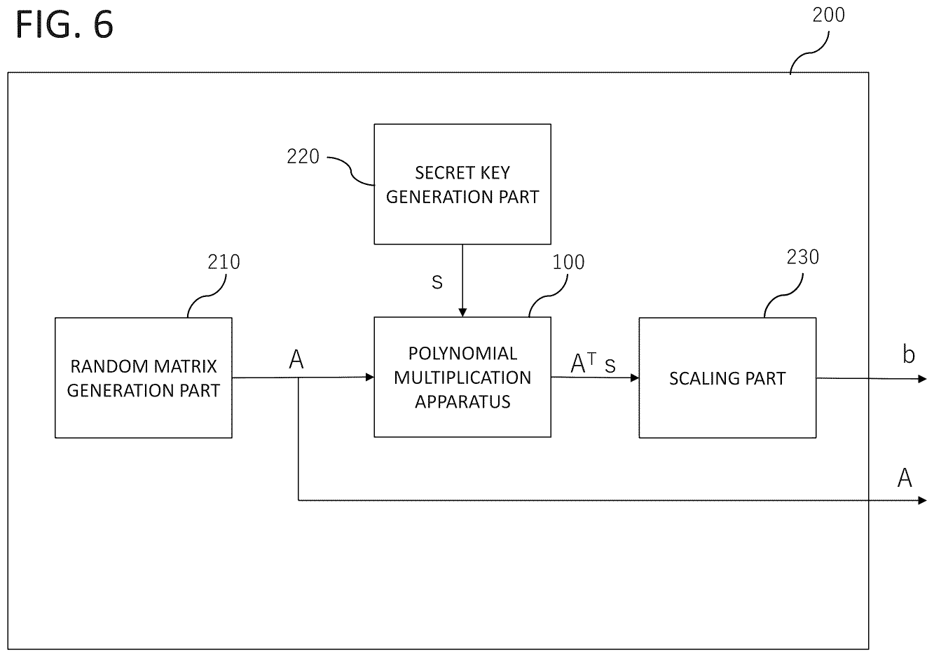

FIG. 6 is a drawing showing an example of the configuration of a key generation apparatus incorporating the polynomial multiplication apparatus. As shown in FIG. 6, the key generation apparatus 200 comprises the polynomial multiplication apparatus 100, a random matrix generation part 210, a secret key generation part 220, and a scaling part 230.

The random matrix generation part 210 uniformly selects the matrix A∈R_{q}^{k×k} at random, and the secret key generation part 220 generates s∈R_{q}^{k} as the secret key.

As described in the first example embodiment, the polynomial multiplication apparatus 100 performs the optimal number of NTT layers on a matrix A^{T} and the secret key s to calculate the product A^{T}s of the matrix A^{T} and the secret key s. Then, the scaling part 230 calculates the scaled and rounded value of A^{T}s and outputs (A, b) as the public key.

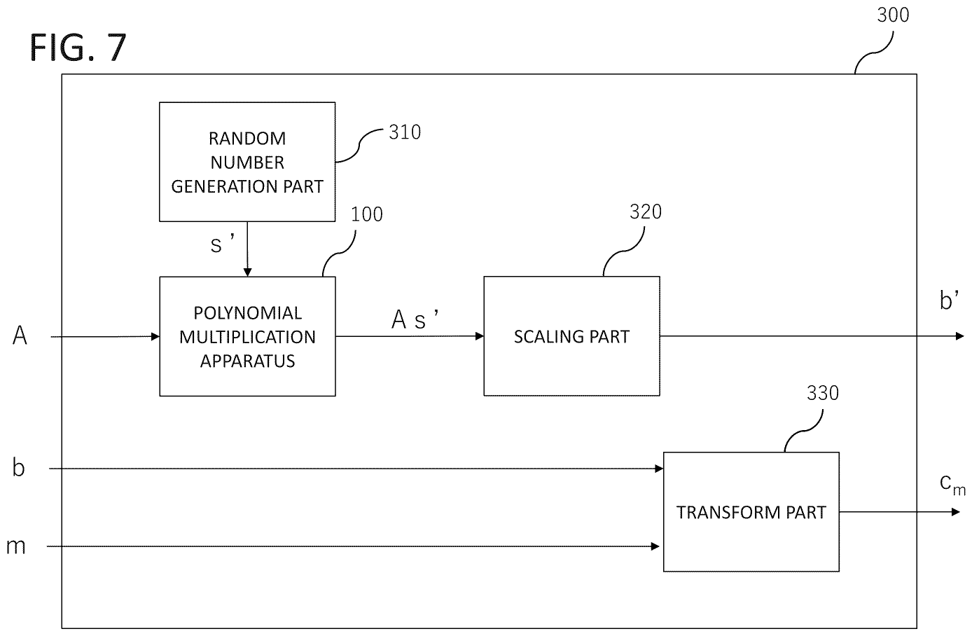

FIG. 7 is a drawing showing an example of the configuration of an encryption apparatus incorporating the polynomial multiplication apparatus. As shown in FIG. 7, the encryption apparatus 300 comprises the polynomial multiplication apparatus 100, a random number generation part 310, a scaling part 320, and a transform part 330.

Next, the random number generation part 310 samples s′∈R_{q}^{k} from a binomial distribution. The polynomial multiplication apparatus 100 multiplies the matrix A, part of the input public key (A, b), and the random number s′. Concretely, as described in the first example embodiment, the polynomial multiplication apparatus 100 performs the optimal number of NTT layers on the matrix A and the random number s′ to calculate the product As' of the matrix A and the random number s′. Then, the scaling part 320 scales the product As' of the matrix A and the random number s′ and outputs b′ as part of the ciphertext.

Meanwhile, the transform part 330 generates cₘ, part of the ciphertext as described above, from the vector b, part of the public key (A, b), and the input plaintext m to output cₘ.

As described, the polynomial multiplication apparatus 100 can be suitably utilized within the key generation apparatus 200 and the encryption apparatus 300 in lattice-based encryption using a polynomial ring. Similarly, a polynomial operation apparatus relating to the first example embodiment can be suitably utilized within the key generation method and the encryption method in lattice-based encryption using a polynomial ring, and a polynomial operation program can be suitably utilized within a key generation program and an encryption program in lattice-based encryption using a polynomial ring.

### Third Example Embodiment

Next, the following describes an example embodiment in which the polynomial multiplication algorithm described above is applied to source code generation.

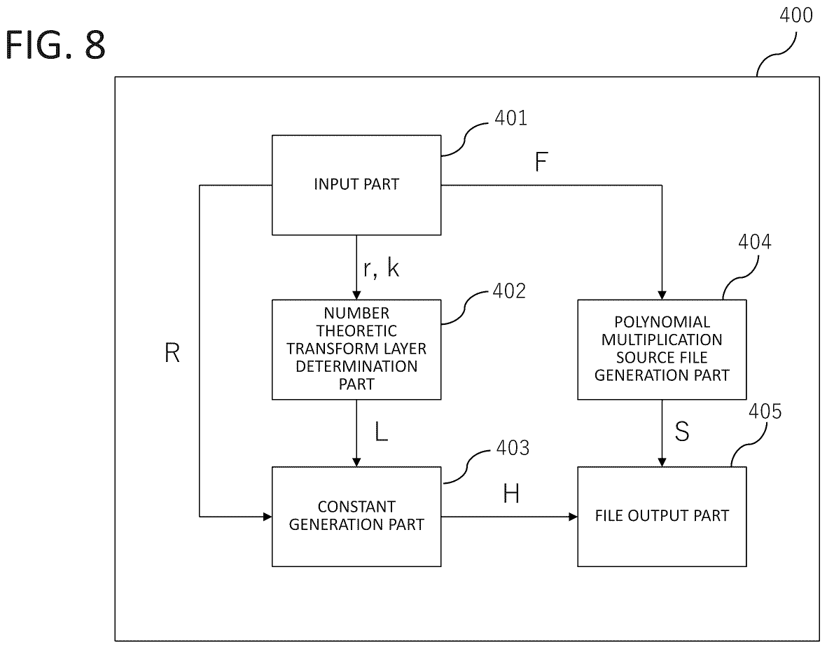

FIG. 8 is a block diagram showing the configuration of a polynomial multiplication source code generation apparatus. As shown in FIG. 8, the polynomial multiplication source code generation apparatus 400 comprises an input part 401, a number theoretic transform layer determination part 402, a constant generation part 403, a polynomial multiplication source file generation part 404, and a file output part 405. Further, the polynomial multiplication source code generation apparatus 400 may be realized using the hardware configuration described with reference to FIG. 4.

The input part 401 takes a file F containing the source code of a modular arithmetic function MontgomeryReduction as an input. The input part 401 further receives as inputs the ratio r of the number of CPU cycles required for one execution of the modular arithmetic function to the number of CPU cycles per one execution of multiplication, the matrix order k, and a word size R. This is achieved, for instance, through a character input device such as a keyboard.

The number theoretic transform layer determination part 402 computes the optimal number L of NTT layers from the cycle ratio r and the matrix order k. This optimal number L of NTT layers can be computed using Math. 1 in the first example embodiment.

The constant generation part 403 generates twiddle factors w, w_inv, a modulo w_mul, and a normalization factor R2invN for L layers of number theoretic transforms and inverse number theoretic transforms to output a list H thereof.

For instance, each of these values can be determined as follows. For a primitive 2\hat{ }(L+1)-th root of unity of a residue ring Z/qZ,

$$w [ i ] = a \hat{} bitrev ( i + 1 ) * ( 2 \hat{} R ) ( mod q ) and$$

$$w\_inv [ i ] = a \hat{} ( - bitrev ( i + 1 ) ) * ( 2 \hat{} R ) ( mod q ) ,$$

$$( i = 0 , 2 , … , 2 \hat{} L - 2 ) ,$$

where bitrev(i) represents the bit-reversed value of i of L bits.

### Further,

$$w\_mul [ i ] = a \hat{} bitrev ( 2 * i + 1 ) * ( 2 \hat{} R ) ( mod q ) ,$$

$$( i = 0 , 1 , … , 2 \hat{} L - 1 )$$

Finally, the normalization factor is determined:

$$R 2 invN = 2 \hat{} ( 2 R - L ) ( mod q )$$

The polynomial multiplication source file generation part 404 a file S which outputs in functions MatrixVectorMul, L_layer_NTT_forward, base_mul, and L_layer_NTT_inv computing the product t=As of the k×k square matrix A and the k-dimensional vector s both having elements belonging to a polynomial ring (Z/qZ)[X]/(X\hat{ }(2\hat{ }N)+1) are implemented in the same programming language as that of the source file F.

The calculation procedure of the function MatrixVectorMul is as follows:

Step 1. Perform L layers of NTTs on each element A[i,j] (i,j=1, 2, . . . , k) of the k×k square matrix A to obtain A′[i,j].
Step 2. Perform L layers of NTTs on each element s[i] (i=1, 2, . . . , k) of the k-dimensional vector s to obtain s′[i].
Step 3. For each j=1, 2, . . . , k,
Calculate the sum of products t′[j]=A′[1,j]*s′[1]+A′[2,j]*s′[2]+ . . . +A′[k, j]*s′[k], where * denotes the element-wise product.
Step 4. Perform L layers of inverse NTTs on each element t′[i] (i=1, 2, . . . , k) of the k-dimensional vector t′ and output the resultant t[i].

Further, the L layers of NTTs in the steps 1 and 2 are implemented by function 2, L_layer_NTT_forward, the sum-of-products calculation in the step 3 is implemented by function 3, base_mul, and the L layers of inverse NTTs in the step 4 are implemented by function 4, L_layer_NTT_inv.

An explanation will be added regarding pseudocode for the sum-of-products calculation in the step 3. Note that an output of L layers of NTTs on a polynomial f is 2\hat{ }L polynomials and each of these polynomials is an element of a polynomial ring (Z/qZ)[X]/(X\hat{ }(2\hat{ }(N−L))−w_mul[u]) (u=0, . . . , 2\hat{ }L−1). Therefore, the calculation of the sum of products t′[j]=A′[1, j]*s′[1]+A′[2, j]*s′[2]+ . . . +A′[k, j]*s′[k] involves multiplication and addition of polynomials belonging to the same polynomial ring.

For instance, the functions MatrixVectorMul, L_layer_NTT_forward, base_mul, and L_layer_NTT_inv are expressed by the following pseudocode:

Function 1: MatrixVectorMul
Input: matrix A; vector s; twiddle factors w, w_inv; modulo w_mul; the
number of layers L
Output: product t = As

| | |
|---|---|
| 1: | for i=0,1,...,k−1 do |
| 2: | for j=0,1,...,k−1 do |
| 3: | A′[i,j] = L_layer_NTT_forward(A[i,j],w,L) |
| 4: | end for |
| 5: | end for |
| 6: | for i=0,1,...,k−1 do |
| 7: | s′[i] = L_layer_NTT_forward(s[i],w,L) |
| 8: | end for |
| 9: | t′ = base_mul(A′,s′,w_mul,L) |
| 10: | t = L_layer_NTT_inv(t′,w_inv,L) |
| 11: | return t |

Function 2: L_layer_NTT_forward
Input: polynomial f = (f[0], f[1], ..., f[2\hat{ }N−1]); twiddle factors w =
(w[0], w[1], ..., w[2\hat{ }L−2]); the number of layers L
Output: f

| | |
|---|---|
| 1: | cnt = 0 |
| 2: | for i=0,1,...,L−1 do |
| 3: | for j=0,1,...,2\hat{ }i−1 do |
| 4: | for k=0,1,...,2\hat{ }(L−i−1)−1 do |
| 5: | for m=0,1,...,2\hat{ }(8−L)−1 do |
| 6: | a = 2\hat{ }(N−L)*(j*2\hat{ }(L−i) + K) + m |
| 7: | b = 2\hat{ }(N−L)*(j*2\hat{ }(L−i) + k + 2\hat{ }(L−i−1)) + m |
| 8: | f[b] = MontgomeryReduction(f[b]*w[cnt]) |
| 9: | tmp = f[a] + f[b] |
| 10: | f[b] = f[a] − f[b] |
| 11: | f[a] = tmp |
| 12: | end for |
| 13: | end for |
| 14: | cnt = cnt + 1 |
| 15: | end for |
| 16: | end for |
| 17: | return f |

Function 3: base_mul
Input: matrix A′; vector s′; modulo w_mul = (w_mul[0], ..., w_mul[2\hat{ }L−
1]); the number of layers L
Output: t′ = A′s′

| | |
|---|---|
| 1: | t′[k][2\hat{ }N] = {0} |
| 2: | for j=0,1,...,k−1 do |
| 3: | for u=0,1,...,2\hat{ }L−1 do |
| 4: | c = 2\hat{ }(N−L)*u |
| 5: | for i=0,1,...,k−1 do |
| 6: | for m=0,1,...,2\hat{ }(N−L)−1 do |
| 7: | for n=1,2,...,2\hat{ }(N−L)−1−m do |
| 8: | t′[j][c+m] += A′[i,j][c+n] * s′[i][c+m+2\hat{ }(N− |

L)−n]

| | |
|---|---|
| 9: | end for |
| 10: | t′[j][c+m] = w_mul[u] * |

MontgomeryReduction (t′[j][c+m])

| | |
|---|---|
| 11: | for n=0,1,...,m do |
| 12: | t′[j][c+m] += A′[i,j][c+n] * s′[i][c+m−n] |
| 13: | end for |
| 14: | t′[j][c+m] = MontgomeryReduction(t′[j][c+m]) |
| 15: | end for |
| 16: | end for |
| 17: | end for |
| 18: | end for |
| 19: | return t |

Function 4: L_layer_NTT_inv
Input: polynomial f = (f[0], f[1], ..., f[2\hat{ }N−1]); twiddle factors w_inv
= (w_inv[0], w_inv[1], ..., w_inv[2\hat{ }L−2]); the number of layers L
Output: f

| | |
|---|---|
| 1: | cnt = 2\hat{ }L−2 |
| 2: | for i=L−1,...,1,0 do |
| 3: | for j=2\hat{ }i−1,...,1,0 do |
| 4: | for k=2\hat{ }(L−i−1),...,1,0 do |
| 5: | for m=0,1,...,2\hat{ }(N−L)−1 do |
| 6: | a = 2\hat{ }(N−L)*(j*2?(L−i) + k) + m |
| 7: | b = 2\hat{ }(N−L)*(j*2?(L−i) + k + 2\hat{ }(L−i−1)) + m |
| 8: | tmp = f[a] + f[b] |
| 9: | f[b] = MontgomeryReduction ((f[a]− |

f[b])*w_inv[cnt])

| | |
|---|---|
| 10: | f[a] = tmp |
| 11: | end for |
| 12: | end for |
| 13: | cnt = cnt − 1 |
| 14: | end for |
| 15: | end for |
| 16: | for i=0,1,...,2\hat{ }N-1 do |
| 17: | f[i] = MontgomeryReduction(f[i]*R2invN) |
| 18: | end for |
| 19: | return f |

The file output part 405 outputs the file S generated by the polynomial multiplication source file generation part 404 and the list H of the values generated by the constant generation part 403. With respect to the list H, for instance, a file S′ having the list H added to the file S may be outputted, or a header file H′ containing the list H may be generated.

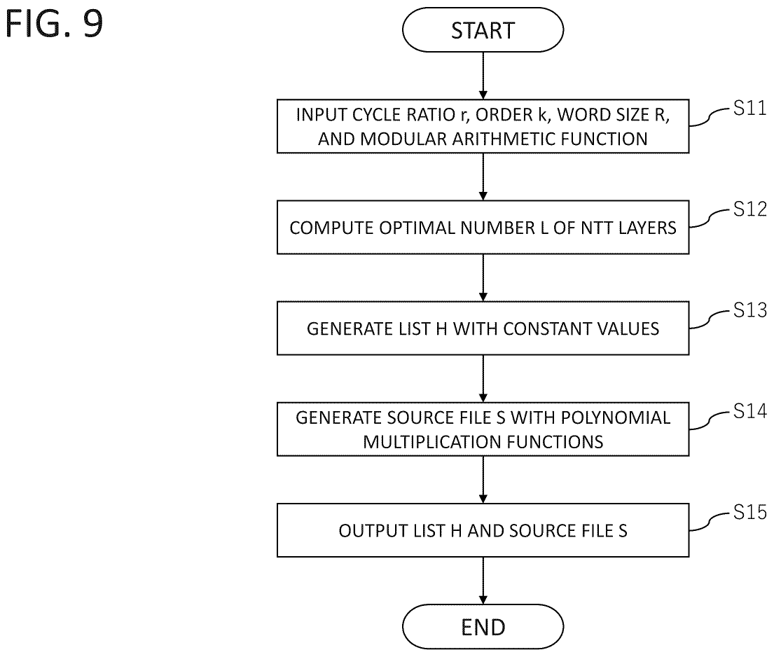

Next, the overall operation of the present example embodiment will be described with reference to a flowchart of FIG. 9. FIG. 9 is a flowchart showing a polynomial multiplication source code generation method.

First, the input part 401 takes as an input the source file F containing the cycle ratio r, the matrix order k, the word size R, and the modular arithmetic function MontgomeryReduction (S11).

Next, the number theoretic transform layer determination part 402 determines the optimal number L of NTT layers from the cycle ratio r and the order k (S12).

Next, the constant generation part 403 computes the twiddle factors w, w_inv, the modulo w_mul, and the constant R2invN for the word size R and the number of layers L and generates the list H containing these values (S13).

Next, the polynomial multiplication source file generation part 404 generates the source file S containing the functions MatrixVectorMul, L_layer_NTT_forward, L_layer_NTT_inv, and base_mul (S14).

Finally, the file output part 405 outputs the list H and the source file S (S15).

The polynomial multiplication algorithm described in the first example embodiment can thus be applied to source code generation.

Some or all of the example embodiments above can be described as (but not limited to) the following Supplementary Notes.

### [Supplementary Note 1]

A polynomial multiplication apparatus multiplying a square matrix and a vector having polynomial elements that are elements of a polynomial ring, the polynomial multiplication apparatus comprising:
an NTT structure determination part that computes an optimal number of layers of number theoretic transforms for inputs of the cycle ratio of the cycle count per one execution of a modular arithmetic function to the cycle count per one execution of multiplication in the polynomial multiplication apparatus and the order of the square matrix and the vector; and
an NTT multiplication part that executes polynomial multiplication of the square matrix and the vector using a number theoretic transform that uses the optimal number of layers of number theoretic transforms.

### [Supplementary Note 2]

The polynomial multiplication apparatus according to Supplementary Note 1 computing the optimal number of layers L of number theoretic transforms using Math. 1 above, where the cycle ratio is r, the order is k, and m=log₂(n) in the polynomial ring R[X]/(Xⁿ−1):

### [Supplementary Note 3]

The polynomial multiplication apparatus according to Supplementary Note 1 or 2, wherein the polynomial multiplication of the square matrix and the vector is used in lattice-based cryptography using a polynomial ring.

### [Supplementary Note 4]

The polynomial multiplication apparatus according to Supplementary Note 3 being incorporated into a key generation apparatus for the lattice-based cryptography using the polynomial ring.

### [Supplementary Note 5]

The polynomial multiplication apparatus according to Supplementary Note 3 being incorporated into an encryption apparatus for the lattice-based cryptography using the polynomial ring.

### [Supplementary Note 6]

A polynomial multiplication method using a computer to multiply a square matrix and a vector having polynomial elements that are elements of a polynomial ring, the polynomial multiplication method including:
computing an optimal number of layers of number theoretic transforms for inputs of the cycle ratio of the cycle count per one execution of a modular arithmetic function to the cycle count per one execution of multiplication in the computer and the order of the square matrix and the vector; and
executing polynomial multiplication of the square matrix and the vector using a number theoretic transform that uses the optimal number of layers of number theoretic transforms.

### [Supplementary Note 7]

A polynomial multiplication program causing a computer to multiply a square matrix and a vector having polynomial elements that are elements of a polynomial ring, the polynomial multiplication program including:
a process of computing an optimal number of layers of number theoretic transforms for inputs of the cycle ratio of the cycle count per one execution of a modular arithmetic function to the cycle count per one execution of multiplication in the computer and the order of the square matrix and the vector; and
a process of executing polynomial multiplication of the square matrix and the vector using a number theoretic transform that uses the optimal number of layers of number theoretic transforms.

### [Supplementary Note 8]

A polynomial multiplication source code generation apparatus comprising:
an input part that takes as inputs a file containing the source code of a modular arithmetic function, the cycle ratio of the cycle count per one execution of the modular arithmetic function to the cycle count per one execution of multiplication, and a square matrix order;
a number theoretic transform layer determination part that computes an optimal number of number theoretic transform layers from the cycle ratio and the order;
an output constant generation part that generates a twiddle factor, a modulo, and a normalization factor for the optimal number of layers of number theoretic transforms and inverse number theoretic transforms to output a list thereof;
a polynomial multiplication source file generation part that generates a file in which a function computing the product of a square matrix and a vector of the order is implemented in the same program as that of the source file; and
a file output part that outputs the file and the list.

### [Supplementary Note 9]

A polynomial multiplication source code generation method including:
taking as inputs a file containing the source code of a modular arithmetic function, the cycle ratio of the cycle count per one execution of the modular arithmetic function to the cycle count per one execution of multiplication, and a square matrix order;
computing an optimal number of number theoretic transform layers from the cycle ratio and the order;
generating a twiddle factor, a modulo, and a normalization factor for the optimal number of layers of number theoretic transforms and inverse number theoretic transforms to output a list thereof;
generating a file in which a function computing the product of a square matrix and a vector of the order is implemented in the same program as that of the source file; and
outputting the file and the list.

### [Supplementary Note 10]

A polynomial multiplication source code generation program causing a computer to execute processes of:
taking as inputs a file containing the source code of a modular arithmetic function, the cycle ratio of the cycle count per one execution of the modular arithmetic function to the cycle count per one execution of multiplication, and a square matrix order;
computing an optimal number of number theoretic transform layers from the cycle ratio and the order;
generating a twiddle factor, a modulo, and a normalization factor for the optimal number of layers of number theoretic transforms and inverse number theoretic transforms to output a list thereof;
generating a file in which a function computing the product of a square matrix and a vector of the order is implemented in the same program as that of the source file; and
outputting the file and the list.

Further, the disclosure of Non-Patent Literature cited above is incorporated herein in its entirety by reference thereto. It is to be noted that it is possible to modify or adjust the example embodiments or examples within the scope of the whole disclosure of the present invention (including the Claims) and based on the basic technical concept thereof. Further, it is possible to variously combine or select (or partially omit) a wide variety of the disclosed elements (including the individual elements of the individual claims, the individual elements of the individual example embodiments or examples, and the individual elements of the individual figures) within the scope of the whole disclosure of the present invention. That is, it is self-explanatory that the present invention includes any types of variations and modifications to be done by a skilled person according to the whole disclosure including the Claims and the technical concept of the present invention. Particularly, any numerical ranges disclosed herein should be interpreted that any intermediate values or subranges falling within the disclosed ranges are also concretely disclosed even without specific recital thereof. In addition, using some or all of the disclosed matters in the literatures cited above as necessary, in combination with the matters described herein, as part of the disclosure of the present invention in accordance with the object thereof shall be considered to be included in the disclosed matters of the present application.

### REFERENCE SIGNS LIST

100: polynomial multiplication apparatus
110: NTT structure determination part
120: NTT multiplication part
121: first L-layer number theoretic transform part
122: second L-layer number theoretic transform part
123: multiplication part
124: L-layer inverse number theoretic transform part
200: key generation apparatus
210: random matrix generation part
220: secret key generation part
230: scaling part
300: encryption apparatus
310: random number generation part
320: scaling part
330: transform part
400: polynomial multiplication source code generation apparatus
401: input part
402: number theoretic transform layer determination part
403: constant generation part
404: polynomial multiplication source file generation part
405: file output part

What is claimed is:

1. A polynomial multiplication apparatus multiplying a square matrix and a vector having polynomial elements that are elements of a polynomial ring, the polynomial multiplication apparatus comprising:
an NTT structure determination part that computes an optimal number of layers of number theoretic transforms for inputs of the cycle ratio of the cycle count per one execution of a modular arithmetic function to the cycle count per one execution of multiplication in the polynomial multiplication apparatus and the order of the square matrix and the vector; and
an NTT multiplication part that executes polynomial multiplication of the square matrix and the vector using a number theoretic transform that uses the optimal number of layers of number theoretic transforms.

2. The polynomial multiplication apparatus according to claim 1 computing the optimal number of layers L of number theoretic transforms using the following formula,
$$\begin{matrix}[ Math . 1 ] & \\ L = floor ( m + {log}_{2} ( \frac{2 + k}{2 k} ) + {log}_{2} ( 1 - \sqrt{1 - {( \frac{2 k}{2 + k} )}^{2} \cdot \frac{2}{1 + r}} ) ) & \end{matrix}$$
where the cycle ratio is r, the order is k, and m=log₂(n) in the polynomial ring R[X]/(Xⁿ−1).

3. The polynomial multiplication apparatus according to claim 1, wherein the polynomial multiplication of the square matrix and the vector is used in lattice-based cryptography using a polynomial ring.

4. The polynomial multiplication apparatus according to claim 3 being incorporated into a key generation apparatus for the lattice-based cryptography using the polynomial ring.

5. The polynomial multiplication apparatus according to claim 3 being incorporated into an encryption apparatus for the lattice-based cryptography using the polynomial ring.

6. A polynomial multiplication method using a computer to multiply a square matrix and a vector having polynomial elements that are elements of a polynomial ring, the polynomial multiplication method including:
computing an optimal number of layers of number theoretic transforms for inputs of the cycle ratio of the cycle count per one execution of a modular arithmetic function to the cycle count per one execution of multiplication in the computer and the order of the square matrix and the vector; and
executing polynomial multiplication of the square matrix and the vector using a number theoretic transform that uses the optimal number of layers of number theoretic transforms.

7. (canceled)

8. A polynomial multiplication source code generation apparatus comprising:
an input part that takes as inputs a file containing the source code of a modular arithmetic function, the cycle ratio of the cycle count per one execution of the modular arithmetic function to the cycle count per one execution of multiplication, and a square matrix order;
a number theoretic transform layer determination part that computes an optimal number of number theoretic transform layers from the cycle ratio and the order;
an output constant generation part that generates a twiddle factor, a modulo, and a normalization factor for the optimal number of layers of number theoretic transforms and inverse number theoretic transforms to output a list thereof;
a polynomial multiplication source file generation part that generates a file in which a function computing the product of a square matrix and a vector of the order is implemented in the same program as that of the source file; and
a file output part that outputs the file and the list.

9. A polynomial multiplication source code generation method including:
taking as inputs a file containing the source code of a modular arithmetic function, the cycle ratio of the cycle count per one execution of the modular arithmetic function to the cycle count per one execution of multiplication, and a square matrix order;
computing an optimal number of number theoretic transform layers from the cycle ratio and the order;
generating a twiddle factor, a modulo, and a normalization factor for the optimal number of layers of number theoretic transforms and inverse number theoretic transforms to output a list thereof;
generating a file in which a function computing the product of a square matrix and a vector of the order is implemented in the same program as that of the source file; and
outputting the file and the list.

10. (canceled)

11. The polynomial multiplication method according to claim 6 computing the optimal number of layers L of number theoretic transforms using the following formula,
$$\begin{matrix}[ Math . 2 ] & \\ L = floor ( m + {log}_{2} ( \frac{2 + k}{2 k} ) + {log}_{2} ( 1 - \sqrt{1 - {( \frac{2 k}{2 + k} )}^{2} \cdot \frac{2}{1 + r}} ) ) & \end{matrix}$$
where the cycle ratio is r, the order is k, and m=log₂(n) in the polynomial ring R[X]/(Xⁿ−1).

12. The polynomial multiplication method according to claim 6, wherein the polynomial multiplication of the square matrix and the vector is used in lattice-based cryptography using a polynomial ring.

13. The polynomial multiplication method according to claim 12 being incorporated into a key generation method for the lattice-based cryptography using the polynomial ring.

14. The polynomial multiplication method according to claim 12 being incorporated into an encryption method for the lattice-based cryptography using the polynomial ring.

15. The polynomial multiplication source code generation apparatus according to claim 8 computing the optimal number of layers L of number theoretic transforms using the following formula,
$$\begin{matrix}[ Math . 3 ] & \\ L = floor ( m + {log}_{2} ( \frac{2 + k}{2 k} ) + {log}_{2} ( 1 - \sqrt{1 - {( \frac{2 k}{2 + k} )}^{2} \cdot \frac{2}{1 + r}} ) ) & \end{matrix}$$
where the cycle ratio is r, the order is k, and m=log₂(n) in the polynomial ring R[X]/(Xⁿ−1).

16. The polynomial multiplication source code generation apparatus according to claim 8, wherein the polynomial multiplication of the square matrix and the vector is used in lattice-based cryptography using a polynomial ring.

17. The polynomial multiplication source code generation apparatus according to claim 16 being incorporated into a key generation apparatus for the lattice-based cryptography using the polynomial ring.

18. The polynomial multiplication source code generation apparatus according to claim 16 being incorporated into an encryption apparatus for the lattice-based cryptography using the polynomial ring.

19. The polynomial multiplication source code generation method according to claim 9 computing the optimal number of layers L of number theoretic transforms using the following formula,
$$\begin{matrix}[ Math . 4 ] & \\ L = floor ( m + {log}_{2} ( \frac{2 + k}{2 k} ) + {log}_{2} ( 1 - \sqrt{1 - {( \frac{2 k}{2 + k} )}^{2} \cdot \frac{2}{1 + r}} ) ) & \end{matrix}$$
where the cycle ratio is r, the order is k, and m=log₂(n) in the polynomial ring R[X]/(Xⁿ−1).

20. The polynomial multiplication source code generation method according to claim 9, wherein the polynomial multiplication of the square matrix and the vector is used in lattice-based cryptography using a polynomial ring.

21. The polynomial multiplication source code generation method according to claim 20 being incorporated into a key generation method for the lattice-based cryptography using the polynomial ring.

22. The polynomial multiplication source code generation method according to claim 20 being incorporated into an encryption method for the lattice-based cryptography using the polynomial ring.
